(19) United States
(12) Patent Application Publication
(10) Pub. No.: US 2023/0245272 A1
(43) Pub. Date: Aug. 3, 2023

(54) THERMAL IMAGE GENERATION

(71) Applicant: Hewlett-Packard Development Company, L.P., Spring, TX (US)

(72) Inventors: Lei CHEN, Palo Alto, CA (US); Sunil KOTHARI, Palo Alto, CA, CA (US); Jun ZENG, Palo Alto (US)

(21) Appl. No.: 18/010,763

(22) PCT Filed: Jun. 19, 2020
(86) PCT No.: PCT/US2020/038774

§ 371 Date: Dec. 15, 2022

(51) Int. Cl. G06T 3/40; G06T 7/00; G06T 17/00; B29C 64/386; B33Y 50/00

(52) U.S. Cl. CPC G06T 3/4046; G06T 7/001; G06T 17/00; B29C 64/386; B33Y 50/00; G06T 2207/30144; G06T 2207/20084; G06T 2207/10024; G06T 2207/20081; G06T 2207/20221; G06T 2207/10048

(57) ABSTRACT

Examples of methods for thermal image generation are described. In some examples, a method may include determining a score map based on first features from a model, a simulated thermal image at a first resolution, and second features of the simulated thermal image. In some examples, the method may include generating a thermal image at a second resolution based on the score map, the first features, and the second features, where the second resolution may be greater than the first resolution.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for thermal image generation;

FIG. 2 is a block diagram illustrating examples of functions that may be implemented for thermal image generation;

FIG. 3 is a block diagram of an example of an apparatus that may be used in thermal image generation;

FIG. 4 is a block diagram illustrating an example of a computer-readable medium for image enhancement;

FIG. 5 is a block diagram illustrating an example of an inception network;

FIG. 6 is a diagram illustrating an example of a residual neural network; and

FIG. 7 is a diagram illustrating examples of some data that may be utilized and/or produced in accordance with some of the techniques described herein.

### DETAILED DESCRIPTION

Additive manufacturing may be used to manufacture three-dimensional (3D) objects. 3D printing is an example of additive manufacturing. Some examples of 3D printing may selectively deposit agents (e.g., droplets) at a pixel level to enable control over voxel-level energy deposition. For instance, thermal energy may be projected over material in a build area, where a phase change (for example, melting and solidification) in the material may occur depending on the voxels where the agents are deposited.

A voxel is a representation of a location in a 3D space. For example, a voxel may represent a volume or component of a 3D space. For instance, a voxel may represent a volume that is a subset of the 3D space. In some examples, voxels may be arranged on a 3D grid. For instance, a voxel may be rectangular or cubic in shape. Examples of a voxel size dimension may include 25.4 millimeters (mm)/150˜170 microns for 150 dots per inch (dpi), 490 microns for 50 dpi, 2 mm, etc. The term “voxel level” and variations thereof may refer to a resolution, scale, or density corresponding to voxel size. In some examples, the term “voxel” and variations thereof may refer to a “thermal voxel.” In some examples, the size of a thermal voxel may be defined as a minimum that is thermally meaningful (e.g., greater than or at least 42 microns or 600 dots per inch (dpi)). A set of voxels may be utilized to represent a build volume. A build volume is a volume in which an object or objects may be manufactured. A “build” may refer to an instance of 3D manufacturing.

In some examples of 3D manufacturing (e.g., Multi Jet Fusion (MJF)), each voxel in the build volume may undergo a thermal procedure (approximately 15 hours of build time (e.g., time for layer-by-layer printing) and approximately 35 hours of additional cooling). The thermal procedure of voxels that include an object may affect the manufacturing quality (e.g., functional quality) of the object.

Thermal sensing may provide an amount of thermal information (e.g., a relatively small amount of spatial thermal information of the build volume and/or a relatively small amount of temporal thermal information over about 50 hours of build and cooling). For example, a thermal sensor (e.g., camera, imager, etc.) may capture about 10 seconds of a thermal voxel's 50-hour procedure when the voxel is exposed as part of a fusing layer, thereby resulting in a lack of temporal coverage. Thermal sensors at the walls and bottom of the build volume may report transient temperatures of a few selected spots, thereby resulting in a lack of spatial coverage.

Some theory-based simulation approaches (e.g., simulations based on thermodynamics laws) may provide additional spatial and temporal information for the thermal procedure (e.g., manufacturing). However, some types of simulations may be computationally expensive, where it may be difficult to achieve a discrete resolution near a print resolution. An example of print resolution is 42 microns in x-y dimensions and 80 microns in a z dimension. It may be useful to provide thermal information at or near print resolution (e.g., 75 dpi) for guiding the placement of an agent or agents (e.g., fusing agent, detailing agent, and/or other thermally relevant fluids). In some examples, there is a sizable gap between the resolutions that process simulation can afford (e.g., approximately 15 dpi) and a print resolution (e.g., approximately 75 dpi in x-y dimensions and 320 dpi in the z dimension).

In some examples, thermal information or thermal behavior may be mapped as a thermal image. A thermal image is a set of data indicating temperature(s) (or thermal energy) in an area. A thermal image may be sensed, captured, simulated, and/or enhanced.

The terms “low resolution” and “high resolution” are utilized herein, where “high resolution” denotes a resolution that is greater than “low resolution.” In some examples, low resolution may refer to a resolution that is less than or not more than 50 dpi (e.g., 25 dpi, 12 dpi, 1 mm voxel dimension, 2 mm voxel dimension, 4 mm voxel dimension, etc.). In some examples, high resolution may refer to a resolution that is greater than or at least 50 dpi (e.g., 150 dpi, 0.17 mm voxel dimension, 0.08 voxel dimension, etc.).

A “simulation voxel” is a discrete volume used for simulation. Simulation voxel size may be set in accordance with a target resolution. For example, simulation voxel size may be set to a print resolution (e.g., approximately the same size as a voxel size for printing), or may be set to be larger for a lower resolution in simulation. In some examples, voxels or simulation voxels may be cubic or rectangular prismatic. An example of three-dimensional (3D) axes includes an x dimension, a y dimension, and a z dimension. In some examples, a quantity in the x dimension may be referred to as a width, a quantity in the y dimension may be referred to as a length, and/or a quantity in the z dimension may be referred to as a height. The x and/or y axes may be referred to as horizontal axes, and the z axis may be referred to as a vertical axis. Other orientations of the 3D axes may be utilized in some examples, and/or other definitions of 3D axes may be utilized in some examples.

While plastics (e.g., polymers) may be utilized as a way to illustrate some of the approaches described herein, some the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi Jet Fusion (MJF), Metal Jet Fusion, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples, “powder” may indicate or correspond to particles insulated with air pockets. An “object” may indicate or correspond to a location (e.g., area, space, etc.) where particles are to be sintered, melted, or solidified that is filled with the material itself without air bubbles or with small air bubbles. For example, an object may be formed from sintered or melted powder.

Some examples of the techniques described herein may utilize a machine learning model or models (e.g., deep learning) to overcome the resolution gap. In some examples, this may enable process simulation results to be utilized for printer operational management. For instance, some of the techniques described herein provide approaches to enhance the resolution of thermal information provided by a simulation. For example, machine learning (e.g., deep learning, neural network(s), etc.) may be applied to enhance resolution of the thermal information. Some examples of machine learning models, once trained, may operate relatively quickly (e.g., on the order of 100 milliseconds per print layer). Accordingly, resolution enhancement may be performed without adding a significant or large amount of computational cost. Examples of the machine learning models described herein may include neural networks, deep neural networks, spatio-temporal neural networks, etc. Some examples of the techniques described herein may utilize each layer of thermal simulation prediction outputs in a time series and generate corresponding higher-resolution thermal images, using information extracted from the model data.

In some examples of the techniques described herein, high-resolution thermal simulation layers may be generated from low-resolution thermal simulation layers. Some examples of the techniques described herein may use the model data and simulated thermal image data as deep learning input. In some examples, deep learning may be applied to increase simulated thermal image resolution in an x-y layer. For example, a deep neural network may utilize model data and a simulated thermal image (e.g., low-resolution build bed thermal simulation output) as input to predict an enhanced thermal image (e.g., high-resolution build bed thermal simulation).

Throughout the drawings, identical or similar reference numbers may designate similar, but not necessarily identical, elements. When an element is referred to without a reference number, this may refer to the element generally, without necessary limitation to any particular Figure. The figures are not necessarily to scale, and the size of some parts may be exaggerated to more clearly illustrate the example shown. Moreover, the drawings provide examples in accordance with the description; however, the description is not limited to the examples provided in the drawings.

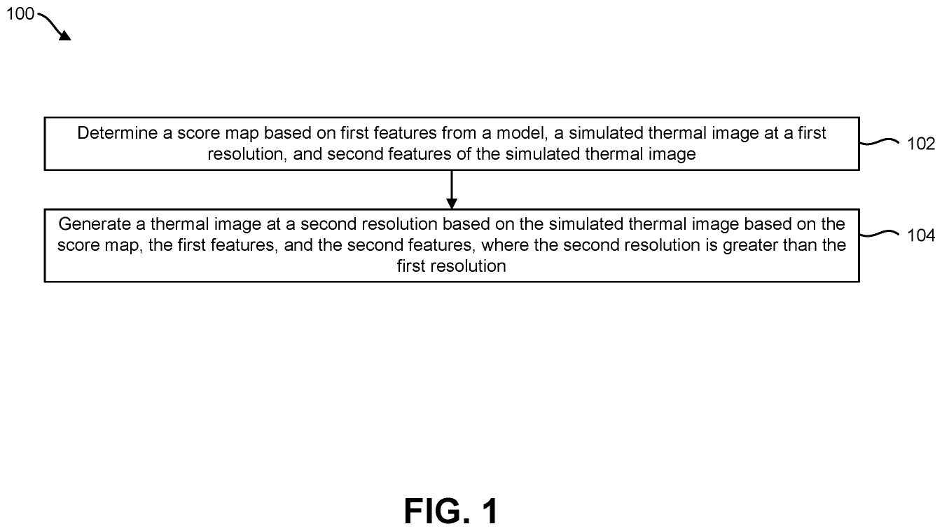

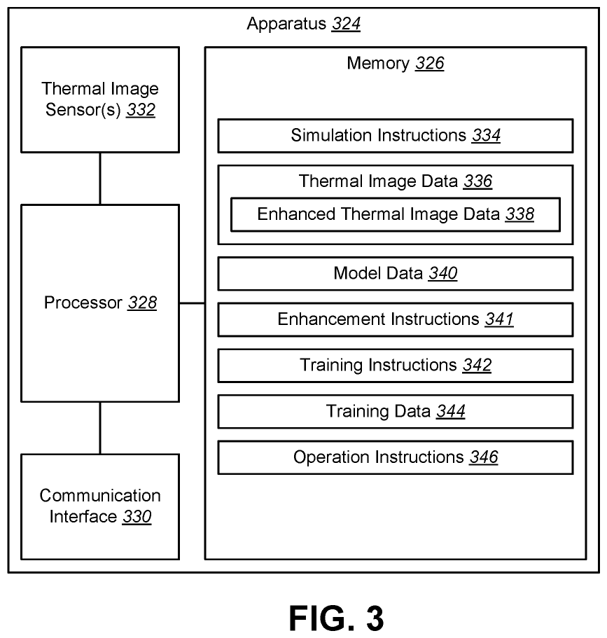

FIG. 1 is a flow diagram illustrating an example of a method 100 for thermal image generation. For example, the method 100 may be performed to produce a thermal image or thermal images. The method 100 and/or an element or elements of the method 100 may be performed by an electronic device. For example, the method 100 may be performed by the apparatus 324 described in relation to FIG. 3.

The apparatus may determine 102 a score map based on first features from a model, a simulated thermal image at a first resolution, and second features of the simulated thermal image. A model is a geometrical model of an object or objects. A model may specify shape and/or size of a 3D object or objects. In some examples, model may be expressed using polygon meshes. For example, a model may be defined using a format or formats such as a 3D manufacturing format (3 MF) file format, an object (OBJ) file format, and/or a stereolithography (STL) file format, etc. In some examples, the model may be received from another device and/or generated.

A simulation of manufacturing is a procedure to model actual manufacturing. For example, simulation may be an approach to provide a prediction of manufacturing. A device (e.g., the apparatus or another device) may simulate the thermal behavior (e.g., transient temperature) of material (e.g., a layer or layers of the material). In some examples, the simulation may be based on a model (of an object or object(s)) and/or a slice or slices. For instance, 3D manufacturing may be simulated for a time range to produce the simulated thermal image. For instance, the simulation may produce temperatures for all or a portion of a build volume. Examples of simulation approaches that may be utilized to generate the simulated thermal image may include finite element analysis (FEA) and/or machine learning approaches. In some examples, the simulation may produce a thermal image or thermal images at a first resolution (e.g., low resolution).

A feature is information that characterizes data. For example, the first features may characterize a model (e.g., a 3D object model). In some examples, a device (e.g., an apparatus or another device) may determine the first features from a model. For instance, the apparatus (or another device) may slice a model. In some examples, slicing may include generating a set of two-dimensional (2D) slices corresponding to the model. A slice is a portion or cross-section. In some approaches, the model (which may be indicated by 3D model data) may be traversed along an axis (e.g., a vertical axis, z-axis, or other axis), where each slice represents a 2D cross section of the 3D model. For example, slicing the model may include identifying a z-coordinate of a slice plane. The z-coordinate of the slice plane can be used to traverse the model to identify a portion or portions of the model intercepted by the slice plane. In some examples, a slice or slices may be expressed as a binary image or binary images.

High-frequency details may be difficult to reconstruct from a low-resolution layer (e.g., thermal image). Slices of the model (e.g., geometrical data) may be utilized to capture the high-frequency details. For example, a slice or slices may correspond to a simulated thermal image. For example, slice data may include geometrical information of the model at a layer level and/or may contribute high frequency information in generating a high-resolution thermal image.

In some examples, a slice or slices may correspond to and/or may be mapped to each low-resolution thermal image. In some examples, a simulated thermal image may be aligned to a sequence of slices, which may be utilized to compensate for geometrical changes in a printing procedure. In some examples, a sequence of slices may be utilized to guide spatial prediction for each low-resolution simulated thermal image. In some examples, the method 100 may include mapping slices (e.g., sequence of slices, adjacent slices, neighboring slices, three slices, four slices, etc.) of the model to color channels to produce a model slice image. A model slice image is an image that indicates a slice or slices of a model. For example, the method 100 may include mapping three slices (e.g., a previous slice, a current slice, and a next slice) to three color channels (e.g., red, green, and blue for a red-green-blue (RGB) image) to produce the model slice image. A model slice image is an image indicating a slice or slices of a model. In some examples, different numbers of slices (e.g., two, three, four, or more) may be mapped to respective color channels (e.g., two, three, four, or more color channels).

In some examples, the method 100 may include determining the first features based on the model slice image. For example, determining the first features may include down-sampling the model slice image to produce a down-sampled model slice image, and producing, using an inception network, the first features based on the down-sampled model slice image. An inception network is a neural network for performing (e.g., applied in) a computer vision task or tasks. For example, an inception network may be used to extract the first features from the slices. An inception network may capture global and local features of multiple sizes with a concatenation of different sized kernels, and/or may reduce network parameters and increase training speed by the application of 1×1 convolution.

In some examples, the method 100 may include determining the second features. For instance, the second features may be determined using a neural network. For example, the method 100 may include determining the second features using a residual neural network. A residual neural network is an artificial neural network. In some examples, an enhanced deep super resolution network (EDSR) may be utilized. For instance, an EDSR framework may apply a version of a residual neural network to increase performance in reconstructing high-resolution thermal images from low-resolution thermal images. In some examples, determining the second features may include adding a residual neural network input (e.g., simulated thermal image) to a residual block output (e.g., the output of a residual block of the residual neural network).

A score map is a set of values. For example, a score map may be a set (e.g., array, matrix, etc.) of weights, where each weight expresses a relevance of a corresponding feature of the first features. For instance, higher weights of the score map may indicate higher relevance of corresponding first features for determining a high-resolution thermal image. In some examples, the score map may be determined by a neural network or a portion of a neural network (e.g., node(s), layer(s), gating neural network, etc.). For instance, a neural network or a portion of a neural network may be trained to determine weights for the first features. In some examples, a neural network or portion of a neural network may be used to determine feature relevance and adaptively fuse the first features from the model and the simulated thermal image (e.g., low-resolution thermal image). For instance, the neural network or portion of a neural network may utilize the first features (based on a slice or slices, for example), the second features (from residual neural network(s), for example), and the simulated thermal image (e.g., the original simulated thermal image), and may infer the score map as a weight map of the first features.

The method may include generating 104 a thermal image at a second resolution based on the score map, the first features, and the second features. The second resolution may be greater than the first resolution. In some examples, generating 104 the thermal image at the second resolution may include multiplying the first features element-wise with the score map to produce weighted first features. In some examples, generating 104 the thermal image at the second resolution may include adding the weighted first features to the second features to produce fused features. Fused features are features that are based on a combination of features. For instance, the first features may be multiplied element-wise by the score map and added to the second features to produce the fused features.

In some examples, generating 104 the thermal image at the second resolution may include generating, using a neural network or a portion of a neural network (e.g., node(s), layer(s), reconstruction neural network, etc.), the thermal image at the second resolution. For instance, generating 104 the thermal image at the second resolution may include generating, using convolutional layers, the thermal image at the second resolution (based on the fused features, for instance). In some examples, the fused features may be provided to the neural network (for reconstruction and/or up-sampling, for instance) to produce the thermal image at the second resolution (e.g., high-resolution thermal image). In some examples, the neural network or portion of a neural network (e.g., reconstruction neural network) may include residual blocks (e.g., 8 residual blocks or another number of residual blocks). In some examples, the neural network or portion of a neural network (e.g., reconstruction neural network) may include an up-sampling layer or layers (e.g., 2 up-sampling layers). In some examples, the up-sampling layer(s) may use sub-pixel convolution to aggregate feature maps (e.g., fused features) from a low-resolution space to produce the thermal image at the second resolution (e.g., high resolution).

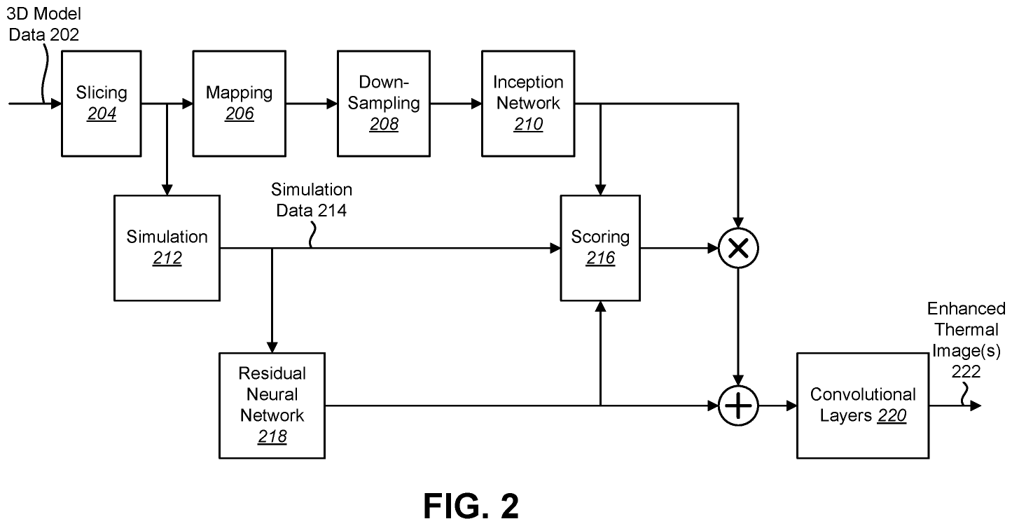

FIG. 2 is a block diagram illustrating examples of functions that may be implemented for thermal image generation. In some examples, one, some, or all of the functions described in relation to FIG. 2 may be performed by the apparatus 324 described in relation to FIG. 3. For instance, instructions for slicing 204, mapping 206, down-sampling 208, an inception network 210, simulation 212, scoring 216, a residual neural network 218, and/or convolutional layers 220 may be stored in memory and executed by a processor in some examples. In some examples, a function or functions (e.g., slicing 204, mapping 206, down-sampling 208, and/or simulation 212, etc.) may be performed by another apparatus. For instance, slicing 204 may be carried out on a separate apparatus and sent to the apparatus.

3D model data 202 may be obtained. For example, the 3D model data 202 may be received from another device and/or generated as described in relation to FIG. 1.

Slicing 204 may be performed based on the 3D model data 202. For example, slicing 204 may include generating a set of 2D slices corresponding to the 3D model data 202 as described in relation to FIG. 1. In some examples, the slices may be provided to mapping 206 and/or simulation 212.

Mapping 206 may be performed based on the slices. For example, mapping 206 may include mapping slices to a model slice image as described in relation to FIG. 1 (e.g., mapping to 3 channels). In some examples, the model slice image may be provided to down-sampling 208.

Down-sampling 208 may be performed based on the model slice image. For example, down-sampling 208 may include reducing the samples of the model slice image and/or lowering the resolution of the model slice image. In some examples, the down-sampled slice image may be provided to the inception network 210.

The inception network 210 may produce first features. For example, the inception network 210 may produce the first features as described in relation to FIG. 1. In some examples, the first features may be provided to scoring 216 and to a multiplier.

The simulation 212 may produce simulation data 214. In some examples, the simulation 212 may produce the simulation data 214 based on the 3D model data 202 and/or a slice or slices. The simulation data 214 may include and/or indicate a simulated thermal image (e.g., a low-resolution thermal image with 1 channel). In some examples, in an x-y plane, the simulation 212 may produce a simulated thermal image with a resolution between 25 dots-per-inch (dpi) and 12 dpi (e.g., with simulation voxel sizes between 1 millimeter (mm) and 2 mm).

In some examples, in the Z dimension, the simulation 212 may group multiple print layers into an artificial print layer. In some examples, a print layer may have a thickness of 0.08 mm. For instance, the simulation 212 may utilize a 2 mm simulation voxel that groups 25 print layers. While examples that utilize 25 layers are described herein, other examples may utilize other numbers of layers.

In some examples, simulation 212 complexity may arise in the time domain. A time T is a production time for a layer or an amount of time for printing a layer. Examples of T for MJF printing include approximately 7 seconds and approximately 10 seconds. In some examples of the simulation 212, simulated printing of each artificial layer may utilize an amount of time equal to a total of the printing times for the layers included in the artificial layer. For example, a 2 mm thick artificial layer may utilize 25*T for simulated layer printing. The simulation data 214 (e.g., simulated thermal image) may be provided to the residual neural network 218 and to scoring 216.

The residual neural network 218 may produce second features. For example, the residual neural network 218 may produce the second features as described in relation to FIG. 1. In some examples, the second features may be provided to scoring 216 and to an adder.

Scoring 216 may produce a score map. For example, scoring 216 may produce a score map as described in relation to FIG. 1. In some examples, the score map may be provided to the multiplier.

The multiplier may produce weighted first features. For example, the multiplier may produce the weighted first features as described in relation to FIG. 1. In some examples, the weighted first features may be provided to the adder.

The adder may produce fused features. For example, the adder may produce the fused features as described in relation to FIG. 1. In some examples, the fused features may be provided to the convolutional layers.

The convolutional layers 220 may produce an enhanced thermal image 222 or enhanced thermal images 222. For example, the convolutional layers 220 may produce a thermal image at a second resolution. For instance, the enhanced thermal image 222 may be a thermal image with a second resolution that is greater than a first resolution of a corresponding simulated thermal image. For instance, a simulated thermal image may have a first resolution in x and y dimensions. The simulated thermal image may be enhanced to produce an enhanced thermal image with a second resolution that is greater in x and y dimensions.

FIG. 3 is a block diagram of an example of an apparatus 324 that may be used in thermal image generation. The apparatus 324 may be a computing device, such as a personal computer, a server computer, a printer, a 3D printer, a smartphone, a tablet computer, etc. The apparatus 324 may include and/or may be coupled to a processor 328, a communication interface 330, a memory 326, and/or a thermal image sensor or sensors 332. In some examples, the apparatus 324 may be in communication with (e.g., coupled to, have a communication link with) an additive manufacturing device (e.g., a 3D printer). In some examples, the apparatus 324 may be an example of 3D printer. The apparatus 324 may include additional components (not shown) and/or some of the components described herein may be removed and/or modified without departing from the scope of the disclosure.

The processor 328 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 326. The processor 328 may fetch, decode, and/or execute instructions stored on the memory 326. In some examples, the processor 328 may include an electronic circuit or circuits that include electronic components for performing a functionality or functionalities of the instructions. In some examples, the processor 328 may perform one, some, or all of the aspects, elements, techniques, etc., described in relation to one, some, or all of FIGS. 1-7.

The memory 326 is an electronic, magnetic, optical, and/or other physical storage device that contains or stores electronic information (e.g., instructions and/or data). The memory 326 may be, for example, Random Access Memory (RAM), Electrically Erasable Programmable Read-Only Memory (EEPROM), a storage device, an optical disc, and/or the like. In some examples, the memory 326 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 326 may be a non-transitory tangible machine-readable storage medium, where the term “non-transitory” does not encompass transitory propagating signals. In some examples, the memory 326 may include multiple devices (e.g., a RAM card and a solid-state drive (SSD)).

The apparatus 324 may further include a communication interface 330 through which the processor 328 may communicate with an external device or devices (not shown), for instance, to receive and store the information pertaining to an object or objects. The communication interface 330 may include hardware and/or machine-readable instructions to enable the processor 328 to communicate with the external device or devices. The communication interface 330 may enable a wired or wireless connection to the external device or devices. The communication interface 330 may further include a network interface card and/or may also include hardware and/or machine-readable instructions to enable the processor 328 to communicate with various input and/or output devices, such as a keyboard, a mouse, a display, another apparatus, electronic device, computing device, etc., through which a user may input instructions into the apparatus 324.

In some examples, the memory 326 may store thermal image data 336. The thermal image data 336 may be obtained (e.g., received) from a thermal image sensor or sensors 332 and/or may be generated. For example, the processor 328 may execute instructions (not shown in FIG. 3) to obtain a captured thermal image or images for a layer or layers. In some examples, the apparatus 324 may include a thermal image sensor or sensors 332, may be coupled to a remote thermal image sensor or sensors, and/or may receive thermal image data 336 (e.g., a thermal image or images) from a (integrated and/or remote) thermal image sensor. Some examples of thermal image sensors 332 include thermal cameras (e.g., infrared cameras). Other kinds of thermal sensors may be utilized. In some examples, thermal sensor resolution may be less than voxel resolution (e.g., each temperature readout may cover an area that includes multiple voxels). For example, a low-resolution thermal camera with a low-resolution (e.g., 31×30 pixels, 80×60 pixels, etc.) may be utilized. In other examples, a high-resolution thermal image sensor or sensors 332 may provide voxel-level (or near voxel-level) thermal sensing (e.g., 640×480 pixels).

The thermal image data 336 may include a sensed thermal image or images. For example, a sensed thermal image may indicate a build area temperature distribution (e.g., thermal temperature distribution over a fusing layer). In some examples, the thermal image sensor or sensors 332 may undergo a calibration procedure to overcome distortion introduced by the thermal image sensor or sensors 332. Different types of thermal sensing devices may be used in different examples. In some examples, the thermal image data 336 may include a simulated thermal image or images.

In some examples, the memory 326 may store model data 340. The model data 340 may include and/or indicate a model or models (e.g., 3D object model(s)). The apparatus 324 may generate the model data 340 and/or may receive the model data 340 from another device. In some examples, the memory 326 may include slicing instructions (not shown in FIG. 3). For example, the processor 328 may execute the slicing instructions to perform slicing on the 3D model data to produce a stack of two-dimensional (2D) vector slices.

The memory 326 may store simulation instructions 334. In some examples, the processor 328 may execute the simulation instructions 334 to produce simulated thermal data. For instance, the processor 328 may produce a simulated thermal image at a first resolution (e.g., low resolution). In some examples, producing a simulated thermal image may be performed as described in relation to FIG. 1 and/or FIG. 2. In some examples, the apparatus 324 may receive simulated thermal data from another device.

The memory 326 may store enhancement instructions 341. For example, the enhancement instructions 341 may be instructions for enhancing a simulated thermal image or images. Enhancing the simulated thermal image or images may include increasing the resolution of the simulated thermal image. In some examples, the enhancement instructions 341 may include data defining and/or implementing a machine learning model or models. In some examples, the machine learning model(s) may include a neural network or neural networks. For instance, the enhancement instructions 341 may define a node or nodes, a connection or connections between nodes, a network layer or network layers, and/or a neural network or neural networks. In some examples, the processor 328 may utilize (e.g., execute instructions included in) the enhancement instructions 341 to determine enhanced thermal images. An enhanced thermal image or images may be stored as enhanced thermal image data 338 on the memory 326. In some examples, the residual neural network(s), inception network(s), reconstruction neural network(s), up-sampling layer(s), and/or convolution layer(s) described herein may be examples of the machine learning model(s) defined by the enhancement instructions 341.

In some examples, the processor 328 may execute the enhancement instructions 341 to determine first features based on a model. For instance, the processor 328 may determine the first features as described in relation to FIG. 1 and/or FIG. 2. For example, the processor 328 may utilize a model or models indicated by the model data 340 to determine the first features.

In some examples, the processor 328 may execute the enhancement instructions 341 to determine second features based on a simulated thermal image. For instance, the processor 328 may determine the second features as described in relation to FIG. 1 and/or FIG. 2. For example, the processor 328 may utilize a simulated thermal image or images indicated by the thermal image data 336 to determine the second features. In some examples, the processor may perform image enhancement using a model and a simulated thermal image as input. For example, the simulated thermal image may be produced with a parameter setting of a low resolution (e.g., large voxel size) for a layer or layers at a time resolution (e.g., set time resolution).

In some examples, the processor 328 may execute the enhancement instructions 341 to generate a thermal image at a second resolution that is greater than the first resolution based on the simulated thermal image, the first features, and the second features. For instance, the processor 328 may determine the thermal image (e.g., enhanced thermal image) at a second resolution as described in relation to FIG. 1 and/or FIG. 2.

In some examples, the memory 326 may store training instructions 342 and/or training data 344. The processor 328 may execute the training instructions 342 to train the machine learning model(s) using the training data 344. Training data 344 is data used to train the machine learning model(s). Examples of training data 344 may include simulated thermal data and/or model data (e.g., slice(s). For example, the training data 344 may include low-resolution simulated thermal images (e.g., simulated thermal images with a relatively large voxel size. In some examples, the training data 344 may include high-resolution simulated thermal images (e.g., simulated thermal images with a finer voxel size). With a high-resolution voxel size setting, the processor 328 may execute the simulation instructions 334 to output the simulated image of each layer at a higher resolution, finer z-dimension distance, and/or finer time resolution. In some examples, the processor 328 may execute the training instructions using the low-resolution simulated thermal images and the corresponding high-resolution simulated thermal images (e.g., layers that match with the low-resolution simulated thermal images). Using the low-resolution simulated thermal images and the high-resolution simulated thermal images, the processor 328 may execute the training instructions to train a machine learning model or models (e.g., residual neural network(s), inception network(s), reconstruction neural network(s), up-sampling layer(s), and/or convolution layer(s) described herein, etc.) to predict an enhanced thermal image from a low-resolution simulated thermal image.

In some examples, the enhanced thermal image may be determined (e.g., predicted and/or inferred) offline and/or independent of any printing of a corresponding object. In some examples, an enhanced thermal image corresponding to a layer may be generated (e.g., predicted, calculated, and/or computed) before, at, or after a time that the layer is formed.

In some examples, for machine learning model training, the processor 328 may execute two simulations: one with a low-resolution (e.g., larger voxel size) setting, and another with a high-resolution (e.g., smaller voxel size) setting. In some examples, the simulation outputs (e.g., low-resolution simulated thermal images and high-resolution thermal images) may each be converted from an output file to a folder of x-y layers, which may represent the per layer thermal distribution at each of a set of timesteps. In some examples, the low-resolution and high-resolution x-y layers and the low-resolution x-y layers the corresponding slice sequences may be mapped (e.g., matched). The low-resolution x-y layer and the corresponding slice sequence may be utilized as input, and the high-resolution x-y layer dataset may be utilized as ground truth for model training.

In some examples, the processor 328 may execute the training instructions 342 to train the machine learning model(s) (e.g., a neural network or neural networks) using a loss function. For example, the training instructions 342 may include a loss function. The processor 328 may compute the loss function based on a high-resolution simulated thermal image and a low-resolution simulated thermal image for training. For example, the high-resolution simulated thermal image for training may provide the ground truth to calculate the loss function. The loss function may be utilized to train the machine learning model(s). For example, a node or nodes and/or a connection weight or weights in the machine learning model(s) (e.g., neural network(s)) may be adjusted based on the loss function in order to increase the prediction accuracy of the machine learning model(s). In some examples, not all of the operations and/or features described in relation to FIG. 3 may be utilized and/or implemented.

When the machine learning model is (or models are) trained, in the inference stage, the apparatus 324 may run the thermal image simulation once (e.g., once for each simulated thermal image), with the low-resolution setting to produce a low-resolution simulated thermal image. The low-resolution simulated thermal image may be utilized as input to the trained model(s) to produce an enhanced (e.g., high-resolution) thermal image.

The memory 326 may store operation instructions 346. In some examples, the processor 328 may execute the operation instructions 346 to perform an operation based on the enhanced thermal image(s). In some examples, the processor 328 may execute the operation instructions 346 to utilize the high-resolution results (e.g., results close to print resolution) to serve another device (e.g., printer controller). For instance, the processor 328 may print (e.g., control amount and/or location of agent(s) for) a layer or layers based on the enhanced thermal image(s). In some examples, the processor 328 may drive model setting (e.g., the size of the stride) based on the enhanced thermal image(s). In some examples, the processor 328 may perform offline print model tuning based on the enhanced thermal image(s). In some examples, the processor 328 may send a message (e.g., alert, alarm, progress report, quality rating, etc.) based on the enhanced thermal image(s). In some examples, the processor 328 may halt printing in a case that the enhanced thermal image(s) indicate or indicates an issue (e.g., more than a threshold difference between a layer or layers of printing and the 3D model and/or slices). In some examples, the processor 328 may feed the enhanced thermal image for the upcoming layer to a thermal feedback control system to online compensate contone maps for the upcoming layer.

In some examples, the processor 328 may execute the operation instructions 346 to compare the thermal image (e.g., enhanced thermal image, high-resolution thermal image, etc.) with a sensed thermal image to detect a nozzle failure or nozzle failures (e.g., failure of a nozzle or nozzles). For instance, a print nozzle defect may be detected and/or compensated by comparing a sensed thermal image or images with a high-resolution thermal image or images (based on the simulated thermal image or images, for example). In some examples, a nozzle defect may be detected if a lower temperature streak pattern is detected relative to neighboring pixels in the print direction. For instance, if a temperature difference (e.g., average temperature difference) in a print direction satisfies a detection threshold, a nozzle defect may be detected. Compensation may be applied by increasing a neighboring nozzle injection amount or changing a layout for print liquid (e.g., agent, ink, etc.) application.

In some examples, the processor 328 may execute the operation instructions 346 to compare the thermal image (e.g., enhanced thermal image, high-resolution thermal image, etc.) with a sensed thermal image to detect powder displacement. Examples of powder displacement may include powder collapse and/or part drag. In some examples, the processor 328 may execute the operation instructions 346 to compare the thermal image with a sensed thermal image to detect part drag and/or powder collapse. For instance, powder collapse and/or part drag may be detected by comparing a sensed thermal image or images with a high-resolution thermal image or images (based on the simulated thermal image or images, for example). In some examples, powder collapse and/or part drag (that occurred during printing, for instance) may be detected if a transient colder region is detected. For instance, if a temperature difference (e.g., average temperature difference) in a region satisfies a detection threshold, powder displacement may be detected.

In some examples, the processor 328 may execute the operation instructions 346 to adjust simulation. For example, the processor 328 may compare the thermal image (e.g., enhanced thermal image, high-resolution thermal image, etc.) with a sensed thermal image (e.g., in-line printer sensing) to tune the simulation.

In some examples, the operation instructions 346 may include 3D printing instructions. For instance, the processor 328 may execute the 3D printing instructions to print a 3D object or objects. In some examples, the 3D printing instructions may include instructions for controlling a device or devices (e.g., rollers, print heads, thermal projectors, and/or fuse lamps, etc.). For example, the 3D printing instructions may use a contone map or contone maps (stored as contone map data, for instance) to control a print head or heads to print an agent or agents in a location or locations specified by the contone map or maps. In some examples, the processor 328 may execute the 3D printing instructions to print a layer or layers. The printing (e.g., thermal projector control) may be based on thermal images (e.g., captured thermal images and/or predicted thermal images). In some examples, the processor 328 may execute the operation instructions to present a visualization or visualizations of the enhanced thermal image(s) on a display and/or send the enhanced thermal image(s) to another device (e.g., computing device, monitor, etc.).

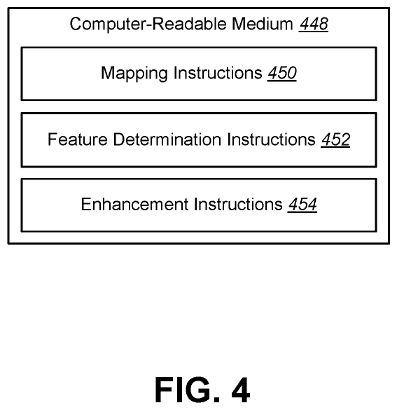

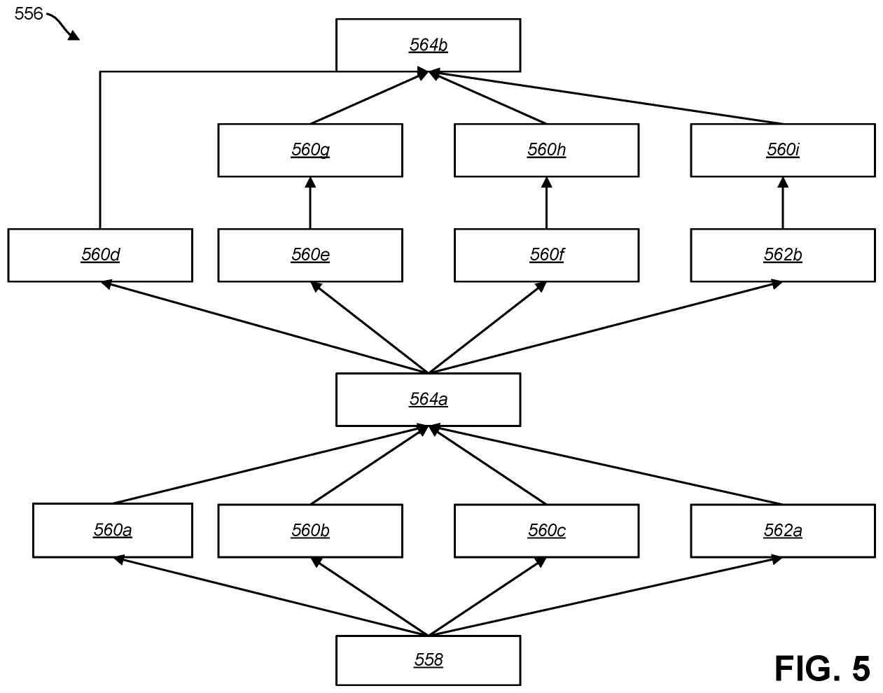

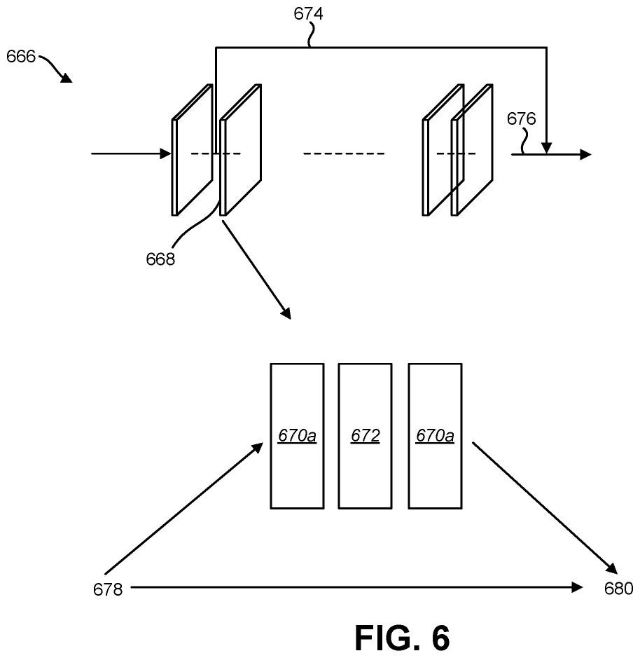

FIG. 4 is a block diagram illustrating an example of a computer-readable medium 448 for image enhancement. The computer-readable medium 448 is a non-transitory, tangible computer-readable medium. The computer-readable medium 448 may be, for example, RAM, EEPROM, a storage device, an optical disc, and the like. In some examples, the computer-readable medium 448 may be volatile and/or non-volatile memory, such as DRAM, EEPROM, MRAM, PCRAM, memristor, flash memory, and the like. In some examples, the memory 326 described in relation to FIG. 3 may be an example of the computer-readable medium 448 described in relation to FIG. 4. In some examples, the computer-readable medium may include code, instructions and/or data to cause a processor perform one, some, or all of the operations, aspects, elements, etc., described in relation to one, some, or all of FIG. 1, FIG. 2, FIG. 3, FIG. 5, and/or FIG. 6.

The computer-readable medium 448 may include code (e.g., data and/or instructions). For example, the computer-readable medium 448 may include mapping instructions 450, feature determination instructions 452, and/or enhancement instructions 454.

The mapping instructions 450 may include code to cause a processor to map slices of a model to produce a model slice image. In some examples, the mapping may be performed as described in relation to FIG. 1, FIG. 2, and/or FIG. 3. For instance, a processor may map a current slice and adjacent slices to color channels of a model slice image. In some examples, the slices may be mapped to three color channels. In some examples, more slices may be utilized, where including more adjacent slices may result in more information being included in the first features.

The feature determination instructions 452 may include code to cause a processor to determine first features based on the model slice image. In some examples, the first features may be determined as described in relation to FIG. 1, FIG. 2, and/or FIG. 3. For instance, the feature determination instructions 452 may include instructions to cause the processor to use an inception network to determine the first features. In some examples, the feature determination instructions 452 may include code to cause a processor to determine second features using a residual neural network. In some examples, the second features may be determined as described in relation to FIG. 1, FIG. 2, and/or FIG. 3.

The enhancement instructions 454 may include code to cause a processor to enhance a resolution of a simulated thermal image based on the first features and second features of the simulated thermal image. In some examples, enhancing the resolution may be performed as described in relation to FIG. 1, FIG. 2, and/or FIG. 3.

FIG. 5 is a block diagram illustrating an example of an inception network 556. The inception network 556 may be an example of the inception networks (e.g., inception network 210) described herein. The inception network 556 may be utilized to produce first features in some examples. In this example, a down-sampled slices image 558 may be provided to convolution component A 560a (with 1×1 dimensions and a stride of 1), to convolution component B 560b (with 3×3 dimensions and a stride of 1), to convolution component C 560c (with 5×5 dimensions and a stride of 1), and to max pooling component A 562a (with 3×3 dimensions and a stride of 1), where corresponding outputs may be provided to filter concatenation A 564a. The output of filter concatenation A 564a may be provided to convolution component D 560d (with 1×1 dimensions and a stride of 1), to convolution component E 560e (with 1×1 dimensions and a stride of 1), to convolution component F 560f (with 1×1 dimensions and a stride of 1), and to max pooling component B 562b (with 3×3 dimensions and a stride of 1). The output of convolution component D 560d may be provided to filter concatenation B 564b. The output of convolution component E 560e may be provided to convolution component G 560g (with 3×3 dimensions and a stride of 1), which may provide an output to filter concatenation B 564b. The output of convolution component F 560f may be provided to convolution component H 560h (with 5×5 dimensions and a stride of 1), which may provide an output to filter concatenation B 564b. Max pooling component B 562b (with 3×3 dimensions and a stride of 1) may provide an output to convolution component I 560i (with 1×1 dimensions and a stride of 1), which may provide an output to filter concatenation B 564b. Filter concatenation B 564b may be utilized to produce first features in some examples.

FIG. 6 is a diagram illustrating an example of a residual neural network 666. The residual neural network 666 may be an example of the residual neural networks (e.g., residual neural network 218) described herein. The residual neural network 666 may include residual blocks 668. In some examples, each residual block 668 may have 64 feature channels for each convolution layer 670a-b. In some examples, a residual block may utilize an activation function 672 (e.g., rectified linear unit (ReLu)). In some examples, the residual neural network 666 may include 32 connected residual blocks 668. Each residual block 668 may have an input 678 and an output 680. In some examples, an input 674 of the residual neural network 666 may be added to the output 676 of the last residual block 668 to produce the second features.

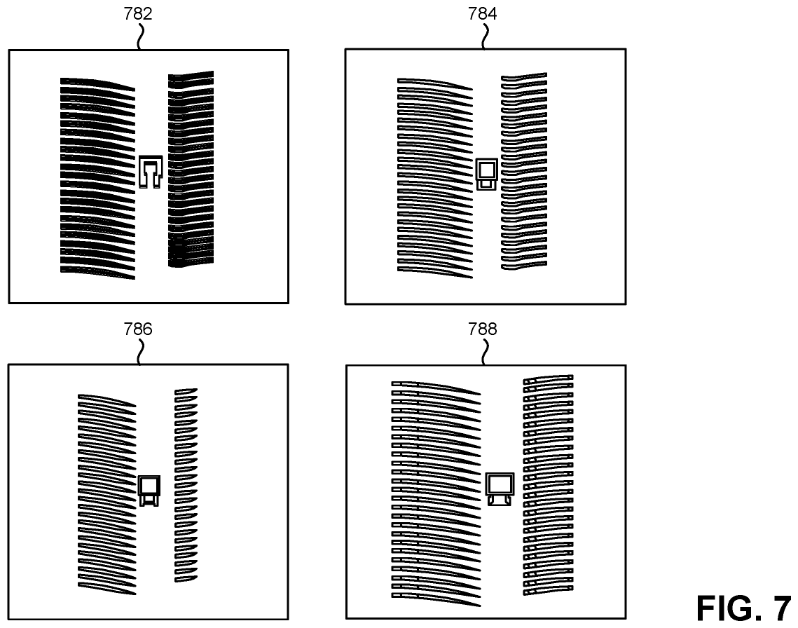

FIG. 7 is a diagram illustrating examples of some data that may be utilized and/or produced in accordance with some of the techniques described herein. For instance, FIG. 7 illustrates a low-resolution simulated thermal image 782 at 15 dpi, a high-resolution thermal image 784 at 75 dpi, a slice 786, and a model slice image 788. As illustrated in FIG. 7, the low-resolution simulated thermal image 782 appears blurry due to containing less information (relative to the high-resolution simulated thermal image 784, for instance).

Some examples of the techniques described herein may utilize a convolutional neural network that uses build geometrical data corresponding to a simulation for reconstructing high-resolution thermal images (e.g., high-resolution simulated thermal images). Detailed geometrical features may be added to produce the fidelity of high-resolution thermal simulation outputs. Once the neural network is trained, the computational cost of inferring high-resolution thermal simulation output is relatively low, thereby managing to bridge the gap between affordable simulation resolution and actual print resolution.

In some examples, a machine learning model may utilize two sets of inputs: a low-resolution thermal simulation layer and corresponding geometrical data (which may be represented by slicer output data arranged in a sequential format, for instance), to predict a high-resolution thermal simulation layer. The machine learning model may provide the fidelity of high-resolution thermal simulation outputs and/or may run faster than high-resolution simulation. In some examples, prediction may be performed in near-real time.

Some of the techniques described herein may enable simulation in contexts beyond offline prediction (e.g., predicting a batch's yield before printing). For instance, simulation may be used in various operations since quantitative results may be provided at print resolution. In some examples, a printer operating system may be utilized to generate a thermal prediction to guide thermal management at a voxel level (e.g., agent fluid generation).

While various examples are described herein, the disclosure is not limited to the examples. Variations of the examples described herein may be implemented within the scope of the disclosure. For example, aspects or elements of the examples described herein may be omitted or combined.

1. A method, comprising:
determining a score map based on first features from a model, a simulated thermal image at a first resolution, and second features of the simulated thermal image; and
generating a thermal image at a second resolution based on the score map, the first features, and the second features, wherein the second resolution is greater than the first resolution.

2. The method of claim 1, further comprising mapping slices of the model to color channels to produce a model slice image.

3. The method of claim 2, further comprising determining the first features based on the model slice image.

4. The method of claim 3, wherein determining the first features comprises:
down-sampling the model slice image to produce a down-sampled model slice image; and
producing, using an inception network, the first features based on the down-sampled model slice image.

5. The method of claim 1, further comprising determining the second features using a residual neural network.

6. The method of claim 5, wherein determining the second features comprises adding a residual neural network input to a residual block output.

7. The method of claim 1, wherein generating the thermal image at the second resolution comprises multiplying the first features element-wise with the score map to produce weighted first features.

8. The method of claim 7, wherein generating the thermal image at the second resolution comprises adding the weighted first features to the second features to produce fused features.

9. The method of claim 8, wherein generating the thermal image at the second resolution comprises generating, using convolutional layers, the thermal image at the second resolution.

10. An apparatus, comprising:
a memory; and
a processor coupled to the memory, wherein the processor is to:
produce a simulated thermal image at a first resolution;
determine first features based on a model;
determine second features based on the simulated thermal image; and
generate a thermal image at a second resolution that is greater than the first resolution based on the simulated thermal image, the first features, and the second features.

11. The apparatus of claim 10, wherein the processor is to compare the thermal image with a sensed thermal image to detect a nozzle failure or nozzle failures.

12. The apparatus of claim 10, wherein the processor is to compare the thermal image with a sensed thermal image to detect part drag or powder collapse.

13. A non-transitory tangible computer-readable medium storing executable code, comprising:
code to cause a processor to map slices of a model to produce a model slice image;
code to cause the processor to determine first features based on the model slice image; and
code to cause the processor to enhance a resolution of a simulated thermal image based on the first features and second features of the simulated thermal image.

14. The computer-readable medium of claim 13, wherein the code to cause the processor to determine the first features comprises code to use an inception network to determine the first features.

15. The computer-readable medium of claim 13, further comprising code to cause the processor to determine the second features using a residual neural network.
